(19) United States
(12) Patent Application Publication
(10) Pub. No.: US 2026/0172765 A1
(43) Pub. Date: Jun. 18, 2026

(54) HEARING AID WITH INTEGRATED SLOT ANTENNA

(71) Applicant: Oticon A/S, Smørum (DK)

(72) Inventor: Jens TROELSEN, Smørum (DK)

(21) Appl. No.: 19/396,407

(22) Filed: Nov. 21, 2025

(30) Foreign Application Priority Data
Dec. 13, 2024 (EP) 24219640.0

(51) Int. Cl. H04R 25/00; H01Q 1/27; H01Q 1/52; H01Q 13/10

(52) U.S. Cl. CPC H04R 25/554; H01Q 1/273; H01Q 1/526; H01Q 13/10; H04R 25/604; H04R 25/609; H04R 2225/51

(57) ABSTRACT

A hearing aid comprising a housing. The housing comprises a first substrate comprising a slot antenna configured to transmit and/or receive wireless signals, a second substrate electrically connected to the power source, and a connecting section electrically connecting the first substrate to the power source via the second substrate. The connecting section comprises a feed line for feeding the slot antenna.

### TECHNICAL FIELD

The present application relates to the field of hearing aids.

### BACKGROUND

Most hearing instruments (HI) support 2.4 GHz communication with other devices and are fitted with a 2.4 GHz antenna.

Key performance indicators for the HI antenna are “antenna efficiency” and “coupling to a device in the pocket”. Both indicators depend on shape of the ear on which the HI is placed, and of course the antenna utilized.

For in the ear (ITE) HI's the integration of an antenna can be an extensive process requiring several decoupling elements and shielding elements to either distance or shield the antenna from other electrical components of the HI. Such elements may increase the final size of the HI making it too bulky for the end-user.

Despite advances in hearing aid technology, integrating efficient antennas into in-the-ear (ITE) devices remains challenging due to space constraints and electromagnetic interference from other components. Existing solutions often require additional shielding or decoupling elements, which can increase device size and reduce user comfort. There is a need for a compact, efficient antenna integration that does not compromise device ergonomics or performance.

The present disclosure addresses the problems of the prior art by providing a compact antenna while maintaining a high antenna efficiency and coupling to a device in the pocket of the end-user.

### SUMMARY

In an aspect of the present application, a hearing aid comprising an antenna is provided. The hearing aid may comprise comprising a housing. The housing may be configured to be positioned in an ear of a user. The housing may comprise an input transducer configured to provide an electrical signal, a power source, a processing unit, a first substrate, a second substrate, and a connecting section. The processing unit may be configured to receive a first input signal based on the electrical signal, and process the first input signal for provision of an output signal. The first substrate may comprise a slot antenna configured to transmit and/or receive wireless signals. The first substrate may comprise an upper edge and a lower edge, where the upper edge is arranged opposing the lower edge, and where the upper edge lies above the lower edge when the hearing aid is worn in an intended position by the user. The second substrate may be electrically connected to the power source. The connecting section may electrically connect the first substrate to the power source via the second substrate. The connecting section may comprise a feed line for feeding the slot antenna.

Thereby an improved hearing aid is provided. The presented hearing aid features a slot antenna providing a high integration level with other components of the hearing aid, while still performing well on key performance indicators of the antenna, such as antenna efficiency and coupling to external electronic devices.

The hearing aid may be adapted to provide a frequency dependent gain and/or a level dependent compression and/or a transposition (with or without frequency compression) of one or more frequency ranges to one or more other frequency ranges, e.g. to compensate for a hearing impairment of a user. The hearing aid may comprise a processing unit for enhancing the input signals and providing a processed output signal.

The hearing aid may comprise an output unit for providing a stimulus perceived by the user as an acoustic signal based on a processed electric signal, e.g., the output signal. The output unit may be a vibrator of a bone conducting hearing aid. The output unit may comprise an output transducer. The output transducer may comprise a receiver (loudspeaker) for providing the stimulus as an acoustic signal to the user (e.g. in an acoustic (air conduction based) hearing aid). The output transducer may comprise a vibrator for providing the stimulus as mechanical vibration of a skull bone to the user (e.g. in a bone-attached or bone-anchored hearing aid). The output unit may (additionally or alternatively) comprise a (e.g. wireless) transmitter for transmitting sound picked up-by the hearing aid to another device, e.g. a far-end communication partner (e.g. via a network, e.g. in a telephone mode of operation).

The hearing aid may comprise an input unit for providing an electric input signal representing sound. The input unit may comprise an input transducer, e.g. a microphone, for converting an input sound to an electric signal. The input unit may comprise a wireless receiver for receiving a wireless signal comprising or representing sound and for providing an electric input signal representing said sound.

The antenna may e.g. be configured to receive and/or transmit an electromagnetic signal in the radio frequency range (3 kHz to 300 GHz).

The hearing aid may comprise antenna and transceiver circuitry allowing a wireless link to an entertainment device (e.g. a TV-set), a communication device (e.g. a telephone), a wireless microphone, a separate (external) processing device, or another hearing aid, etc. The hearing aid may thus be configured to wirelessly receive a direct electric input signal from another device. Likewise, the hearing aid may be configured to wirelessly transmit a direct electric output signal to another device. The direct electric input or output signal may represent or comprise an audio signal and/or a control signal and/or an information signal.

In general, a wireless link established by antenna and transceiver circuitry of the hearing aid can be of any type. The wireless link may be a link based on near-field communication, e.g. an inductive link based on an inductive coupling between antenna coils of transmitter and receiver parts. The wireless link may be based on far-field, electromagnetic radiation. Preferably, frequencies used to establish a communication link between the hearing aid and the other device is below 70 GHz, e.g. located in a range from 50 MHz to 70 GHz, e.g. above 300 MHz, e.g. in an ISM range above 300 MHz, e.g. in the 900 MHz range or in the 2.4 GHz range or in the 5.8 GHz range or in the 60 GHz range (ISM=Industrial, Scientific and Medical, such standardized ranges being e.g. defined by the International Telecommunication Union, ITU). The wireless link may be based on a standardized or proprietary technology. The wireless link may be based on Bluetooth technology (e.g. Bluetooth Low-Energy technology, e.g. LE audio), or Ultra WideBand (UWB) technology.

The hearing aid may be constituted by or form part of a portable (i.e. configured to be wearable) device, e.g. a device comprising a local energy source, e.g. a battery, e.g. a rechargeable battery. The hearing aid may e.g. be a low weight, easily wearable, device, e.g. having a total weight less than 100 g, such as less than 20 g, such as less than 5 g.

The hearing aid may be configured to operate in different modes, e.g. a normal mode and one or more specific modes, e.g. selectable by a user, or automatically selectable. A mode of operation may be optimized to a specific acoustic situation or environment, e.g. a communication mode, such as a telephone mode. A mode of operation may include a low-power mode, where functionality of the hearing aid is reduced (e.g. to save power), e.g. to disable wireless communication, and/or to disable specific features of the hearing aid.

The hearing aid may comprise a hearing instrument, e.g. a hearing instrument adapted for being located at the ear or fully or partially in the ear canal of a user.

The housing may be configured to be positioned in the ear of the user. The housing may comprise one or more electrical components, such as a battery, a loudspeaker, a microphone, an amplifier, etc. The housing may comprise a support structure for supporting the antenna and/or one or more electrical components. The support structure may comprise a printed circuit board, and/or a flexible printed circuit board. The support structure may comprise a molded plastic part. The housing may be form-shaped for the user of the hearing aid. The housing may comprise a top side, a bottom side, a bottom side, a first side part and a second side part opposite the first side part. The top side may be configured to be above the bottom side while the hearing aid is worn by a user in an intended wear position. The first side part may face towards the head of the user while the hearing aid is worn by the user in an intended wear position. The second side part may face away from the head of the user while the hearing aid is worn by the user in an intended wear position. The housing may comprise an input transducer configured to provide an electrical signal. The input transducer may be a microphone or similar configured to convert an incoming sound to an electrical signal. The housing may be configured to be arranged in the ear of the user of the hearing aid.

The processing unit may be configured to receive the first input signal. The first input signal may be derived based on an electrical signal provided by an input transducer of the hearing aid. The first input signal may be derived based on a wireless signal received via the antenna of the hearing aid. The processing unit may be configured to process the first input signal for provision of the output signal. The output signal may be a signal to be presented to a user of the hearing aid. The output signal may be a signal to be transmitted to another device communicatively connected to the hearing aid. The processing unit may be configured to process the first input signal to compensate for a hearing loss of the user of the hearing aid. The processing unit may comprise micro-electronic-mechanical systems (MEMS), integrated circuits (e.g. application specific), microprocessor units, microcontrollers, digital signal processing units (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure.

The power source may be a battery arranged within the housing of the hearing aid. The power source may be a rechargeable battery. The power source may be a single use battery.

The first substrate may be a PCB arranged within the housing. The first substrate may be a flexible PCB arranged within the housing. The first substrate may be formed with a substantially planar geometry, e.g., as a board or similar. The first substrate may be a multilayer structure, e.g., a multilayer PCB or multilayer flexible PCB. The layers of the first substrate may alternate both in material, structure and function. The first substrate may comprise an upper edge and a lower edge, where the upper edge is arranged opposing the lower edge, where the upper edge lies above the lower edge when the hearing aid is worn in an intended position by the user.

The first substrate may comprise a slot antenna. The slot antenna being antenna configured to transmit and/or receive wireless signals. The slot antenna may be formed in the first substrate. The slot antenna may be formed in a layer of first substrate.

The first substrate may be realized as a printed circuit board (PCB) or a flexible printed circuit board (flex PCB). The substrate may be constructed as a multilayer structure, comprising one or more internal layers dedicated to electrical routing and outer layers that provide mechanical support and electromagnetic shielding.

The geometry of the first substrate may be planar, conforming to the internal contours of the hearing aid housing. The first substrate may comprises an upper edge and a lower edge, with the upper edge positioned above the lower edge when the hearing aid is worn in its intended orientation. The slot antenna may be integrated into the first substrate, typically formed as an aperture or slot in a conductive layer. In certain embodiments, the slot antenna may be configured as an open-ended, quarter-wavelength slot, with the open end located at the upper edge of the substrate to optimize wireless performance, particularly for coupling to external devices.

A feed line may be implemented as a co-planar waveguide or microstrip, extends from the connecting section onto the first substrate to feed the slot antenna. The feed point may be located proximate to the lower edge of the substrate, facilitating impedance matching and minimizing feed line length. The first substrate may act as a ground plane for the slot antenna, with one or more layers dedicated to this function in a multilayer configurations.

In addition to the antenna, the first substrate may accommodate electrical routing and mounting locations for other components, such as microphones, sensors, or control circuitry. Conductive traces within the internal layer may provide connections for these components while minimizing interference with the antenna. For example, microphones may be positioned near opposing edges of the substrate, with their inlets arranged to lie substantially within the same horizontal plane when the device is worn, thereby enabling advanced spatial audio processing.

Mechanically, the first substrate may conform to the shape of the hearing aid's faceplate or internal support structure and may be arranged flush with the faceplate or supported by internal features of the housing. Electrical and mechanical connection to the second substrate may be achieved via a connecting section, which may be a flexible PCB segment or a set of wires, providing both power and signal connections as well as the antenna feed. In certain embodiments, the first substrate, second substrate, and connecting section are fabricated as a single integrated flexible PCB, with the connecting section formed as a single-layer flexible region to facilitate assembly.

Optionally, dielectric loading materials may be positioned above and below the slot antenna on the first substrate to reduce the physical size of the antenna while maintaining the desired electrical length. The first substrate may include shielding features or coatings to enhance electromagnetic compatibility.

The second substrate may be a PCB arranged within the housing. The second substrate may be a flexible PCB arranged within the housing. The second substrate may be formed with a substantially planar geometry, e.g., a board or similar. The second substrate may be a multilayer structure, e.g., a multilayer PCB or multilayer flexible PCB. The layers of the second substrate may alternate both in material, structure and function. The second substrate may be configured to accommodate electronics of the hearing aid, e.g., the processing unit and/or transceiver circuitry for the slot antenna may be comprised by the second substrate.

The second substrate may integration and interconnection of components such as the power source, processing circuitry, and transceiver elements. The second substrate may be a printed circuit board (PCB) or a flexible printed circuit board (flex PCB), selected to accommodate the spatial and mechanical constraints of the hearing aid's internal architecture. The second substrate may be constructed as a multilayer structure, with internal layers dedicated to electrical routing and outer layers providing mechanical stability and electromagnetic shielding.

The geometry of the second substrate may be planar, and its dimensions are tailored to fit within the lower region of the hearing aid housing. The second substrate may be arranged parallel to the first substrate. The second substrate may be electrically connected to the power source, which may be a rechargeable or single-use battery arranged within the housing. Electrical routing on the second substrate may provide power distribution to various components, including the processing unit and the slot antenna on the first substrate.

The second substrate may accommodate the processing unit, which may include microprocessors, digital signal processors (DSPs), or application-specific integrated circuits (ASICs) responsible for signal processing, wireless communication, and device control. The second substrate may support transceiver circuitry for managing wireless links with external devices, as well as additional components such as memory, sensors, or interface elements.

The second substrate may be mechanically and electrically connected to the first substrate via a connecting section, which may be implemented as a flexible PCB segment or a set of wires. The connecting section may facilitate the transfer of power and data signals between the first substrate and the second substrate. The connecting section may comprise the feed line for the slot antenna.

The connecting section may electrically connect the first substrate to the power source via the second substrate. The connecting section may comprise a feed line for feeding the slot antenna. The connecting section may comprise one or more wires for electrically connecting the first substrate to the second substrate. The connecting section may comprise a flexible PCB for electrically connecting the first substrate to the second substrate. The connecting section may form an integral part of the first substrate and/or the second substrate.

The connecting section may serve as an interface between the first substrate and the second substrate, enabling both electrical and mechanical interconnection of these components. The connecting section may be implemented as a flexible printed circuit board (flex PCB) segment, which provides the necessary flexibility to accommodate the spatial arrangement of the substrates within the compact housing of an in-the-ear (ITE) hearing aid. The connecting section may be fabricated as an integral part of the first and/or second substrate, particularly when these substrates are also formed from flexible PCB material.

Structurally, the connecting section may be formed as a single-layer or reduced-layer region, which facilitates bending and allows the section to be routed within the limited internal space of the hearing aid. This design enables the connecting section to bridge the gap between the first and second substrates, maintaining a defined distance and orientation between them. The connecting section may act as a spacer, ensuring mechanical stability and proper alignment of the substrates during assembly and operation.

The connecting section may comprises routing for power, data, and control signals between the first and second substrates. The connecting section may comprise a dedicated feed line for the slot antenna, which may be implemented as a co-planar waveguide or microstrip line to ensure signal integrity and minimize losses. Additional electrical traces within the connecting section may provide connections for other components, such as microphones or sensors mounted on the first substrate, enabling their integration with the processing circuitry and power source located on the second substrate.

The connecting section may soldered to the first substrate at the lower edge and to the second substrate at a corresponding interface. The use of a flexible PCB for the connecting section allows for a smaller bending radius, increasing design freedom and enabling more compact device construction. Optionally, the connecting section may include features for electromagnetic shielding or reinforcement to enhance durability and compatibility.

When the first substrate, second substrate, and connecting section are fabricated as a single integrated flexible PCB, the connecting section may be formed as a narrow, flexible bridge between the multilayer regions of the substrates. This approach simplifies assembly, reduces the number of discrete components, and improves overall reliability by minimizing the number of solder joints and connectors required within the device.

The feed line may extend from the connecting section onto/in the first substrate to the slot antenna. Preferably, the feed line extends in a straight line from the connecting section to the slot antenna to minimize the length of the feed line and space occupied by the feed line.

The first substrate, the second substrate and the connecting section may be provided as a single flexible PCB.

The slot antenna may be configured to enable wireless communication for the hearing aid. The slot antenna may be formed as an aperture or slot in a conductive layer of the first substrate, which may be a printed circuit board (PCB) or a flexible printed circuit board (flex PCB). The geometry of the slot antenna may be tailored to the desired operating frequency, such as the 2.4 GHz ISM band commonly used for Bluetooth and other wireless protocols.

In one embodiment, the slot antenna is configured as an open-ended, quarter-wavelength slot, with the open end positioned at the upper edge of the first substrate. This arrangement has been found to reduce path loss to external devices, such as smartphones or remote microphones, particularly when these devices are located in the user's pocket. The slot may be straight or meandering, with bends incorporated to further reduce the physical footprint of the antenna while maintaining the required electrical length for resonance at the target frequency.

The slot antenna may be fed via a dedicated feed line, which may be implemented as a co-planar waveguide or microstrip line extending from the connecting section onto the first substrate. The feed point may be located proximate to the lower edge of the substrate, optimizing impedance matching and minimizing feed line length. In certain embodiments, the feed point is positioned at or near the 50 Ohm impedance location to ensure efficient power transfer from the transmitter circuitry to the antenna.

The first substrate itself may serve as a ground plane for the slot antenna, with one or more conductive layers surrounding the slot to provide the necessary electromagnetic environment for efficient radiation and reception. In multilayer substrate configurations, specific layers may be dedicated to ground, while others accommodate signal routing and component mounting.

To further enhance performance and miniaturization, the slot antenna may be loaded with dielectric materials positioned above and/or below the slot. These loading substrates increase the effective permittivity around the antenna, allowing for a shorter physical slot length while preserving the desired electrical characteristics. The loading materials may be integrated into the faceplate or internal support structures of the hearing aid.

The design of the slot antenna may be adaptable to various hearing aid configurations and can be optimized for different frequency bands or wireless standards as required. The integration of the slot antenna within the first substrate enables a high degree of miniaturization, robust wireless performance, and seamless assembly within the compact housing of an in-the-ear hearing aid.

In an embodiment, the connecting section is provided as a single layer structure. By providing the connecting section as a single layer structure it may facilitate bending of the connecting section, thus allowing the connecting section to connect to the first substrate and the second substrate with a smaller bending radius, thus allowing for increased freedom in constructing the housing for the hearing aid.

In an embodiment, the first substrate, the second substrate and the connecting section are provided as a single flexible PCB, wherein the first substrate and/or the second substrate are provided as multilayer structures, and the connecting section is provided as a single layer structure.

The connecting section may act as a spacer between the first substrate and the second substrate. The connecting section may be configured to maintain the desired amount of space between the first substrate and the second substrate. A distance between the first substrate and the second substrate may be defined by the connecting section. The shortest distance between the first substrate and the second substrate may be defined by the connecting section.

The first substrate may define a first plane. The second substrate may define a second plane. The connecting section may be configured to extend in a third plane extending between first plane and the second plane. The first plane may be parallel with the second plane. The third plane may extend perpendicularly to the first plane and the second plane. A distance between the first plane and the second plane may be defined by the connecting section.

The connecting section may be connected to the first substrate at the lower edge of the first substrate. The connection between the connecting section and the first substrate may be achieved by soldering the connecting section to the first substrate. A connection between the connecting section and the second substrate may be achieved by soldering the connecting section to the second substrate.

A minimum distance between the first substrate and the second substrate may be 0.5 mm, 1 mm or more. The housing may comprise a support structure for supporting the first substrate and/or the second substrate. The support structure may support one or more components arranged within the housing. The support structure may be configured to act as a spacer between the first substrate and the second substrate.

In an embodiment, the hearing aid comprises a faceplate, and where the first substrate conforms to the faceplate.

The faceplate may be a part of the hearing aid which faces outward when the hearing aid is worn. The faceplate may comprise one or more buttons allowing the user of the hearing aid to interact with the hearing aid.

The faceplate may correspond to a baseplate of the hearing aid.

The first substrate may conform at least partially to the faceplate. The first substrate may be arranged flush with the faceplate.

In an embodiment, the slot antenna is configured to be fed at the 50 Ohm point.

By feeding the antenna at the 50 Ohm point it allows efficient power transmission from the transmitter to the antenna. Alternatively, the antenna may be fed at 5-500 Ohm, 10-200 Ohm or 20-100 Ohm.

In an embodiment, the slot antenna is open-ended and formed as a quarter wavelength slot.

In the present disclosure an open-ended slot antenna may be understood as a slot antenna where only one end of the antenna is fully surrounded by electrically conductive material.

In an embodiment, the open-end of the slot antenna is arranged at the upper edge.

The inventors have found that by arranging the open-end of the slot at the upper edge decreases the pathloss to a device placed in the pocket of a user of the hearing aid.

In an embodiment, the slot antenna is fed proximately to the lower edge.

In the present disclosure, the slot antenna being fed proximately to the lower edge may be understood as the slot antenna being fed at the part of the slot antenna closest to the lower edge. Proximate the lower edge may be understood as closer to the lower edge than the upper edge.

In an embodiment, the first substrate defines a ground plane for the slot antenna.

The first substrate may act as a ground plane for the slot antenna. If the first substrate is a multilayered substrate one or more layers of the substrate may act as a ground plane for the slot antenna. The one or more layers of the first substrate in which the slot antenna is formed may act as a ground plane for the slot antenna. The slot antenna may be formed as a through-going slot through the first substrate, thus the first substrate surrounding the slot may act as a ground place for the slot antenna.

In an embodiment, the first substrate comprises one or more electrical components.

The one or more electrical components may comprise sensors, microphones, diodes, circuitry for a button, etc. The one or more electrical components may comprise the slot antenna. The first substrate may comprise the slot antenna and one or more further electrical components. The one or more further electrical components may comprise sensors, microphones, diodes, circuitry for a button, etc

In an embodiment, the first substrate comprises first electrical routing for the one or more electrical components.

The first electrical routing may comprise wiring, electrical lines, and/or other electrical connections. The first electrical routing may comprise one or more feed lines for feeding the slot antenna. The first electrical routing may be arranged in one or more layers of the first substrate. The first electrical routing may comprise electrical routing for the slot antenna and one or more further electrical components.

In an embodiment, the first substrate comprises a first outer layer, a second outer layer opposite the first outer layer and one or more internal layers, where the one or more internal layers comprises the first electrical routing.

Consequently, the first electrical routing may be hidden from the slot antenna, i.e., minimize the influence of the first electrical routing on the antenna characteristics.

The first outer layer and the second outer layer may be outermost layers of the first substrate. The one or more internal layers may be layers of the first substrate sandwiched between the first outer layer and the second outer layer. Thus, the outer layers may shield the slot antenna from the first electrical routing.

Electrical routing may in the present disclosure be understood as electronic facilitating the transport of power and/or data, such conductive traces, wiring, grounding, etc.

In an embodiment, the connecting section comprises second electrical routing for the one or more electrical components.

The second electrical routing may comprise wiring, electrical lines, and/or other electrical connections. The second electrical routing may be electrically connected to the first electrical routing of the first substrate. The second electrical routing may comprise one or more feed lines for the slot antenna. The second electrical routing may comprise electrical routing for one or more further electrical components.

In an embodiment, the feed line for feeding the slot antenna comprises a co-planar waveguide.

In an embodiment, the one or more electrical components comprises a first microphone arranged proximate a first edge extending between the upper edge and the lower edge, and a second microphone arranged proximate a second edge extending between the upper edge and the lower edge opposite the first edge.

By arranging the microphones at opposing edges of the first substrate, it may ensure sufficient distance between the microphones to allow for spatial processing of the audio signals provided by the microphones, e.g., beamforming or other similar spatial processing.

In an embodiment, the first microphone and the second microphone are arranged such that an inlet of the first microphone and an inlet of the second microphone are substantially within the same horizontal plane when the hearing aid is worn in an intended position.

Consequently, the microphones are arranged to optimize spatial processing for audio sources horizontally displaced relative to the user of the hearing aid.

In an embodiment, the connecting section comprises a flexible printed circuit board.

The flexible printed circuit board of the connecting section may be provided as an integrated piece of the first substrate and/or the second substrate, especially if the first substrate and/or the second substrate are provided as flexible printed circuit boards.

In an embodiment, the slot antenna comprises a meandering slot antenna.

By providing the slot antenna as a meandering antenna it allows the slot antenna to have a compact design suitable for an ITE hearing aid.

By a meandering slot antenna in the present disclosure may be understood a slot antenna comprising one or more bends.

In an embodiment, the hearing aid comprises a first loading substrate and a second loading substrate, wherein the first loading substrate is arranged over the slot antenna and the second loading substrate is arranged under the slot antenna opposite the first loading substrate, wherein the first loading substrate and the second loading substrate are configured to load the slot antenna.

By providing loading materials on the slot antenna, it may reduce the physical size of the antenna while still achieving the sufficient electrical length of the antenna to achieve resonance within desired frequencies.

Loading of the antenna may be understood as adding inductance to the antenna to change the electrical length of the antenna without changing the physical length of the antenna.

The first loading substrate may have an electrical permittivity of 5-10, preferably 7. The first loading substrate may be a polymer material. The first loading substrate may comprise the faceplate of the hearing aid.

The second loading substrate may have an electrical permittivity of 5-10, preferably 7. The second loading substrate may be a polymer material. The second loading substrate may comprise a support structure of the hearing aid, i.e., a rack or other structure comprised by the housing of the hearing aid configured to support one or more components arranged within the housing of the hearing aid.

In an embodiment the second substrate comprises a first side and a second side opposite the first side, where the first side faces towards the power source, and where the second side faces towards the first substrate.

By having the power source and the first substrate arranged facing opposing sides of the second substate provides several advantages. Arranging the second substrate in-between the power source and first substrate it may reduce electromagnetic interference in the slot antenna, and shield and distance the slot antenna from the battery, thus reducing potential interference between the power circuit and the slot antenna or other sensitive electronics on the first substrate. By interposing the second substrate in-between the first substrate and the power source it may reduce the risk of cross-talk, noise, or accidental short, thus enhancing the overall reliability and durability of the hearing aid.

The hearing aid may be adapted to provide a frequency dependent gain and/or a level dependent compression and/or a transposition (with or without frequency compression) of one or more frequency ranges to one or more other frequency ranges, e.g. to compensate for a hearing impairment of a user. The hearing aid may comprise a signal processor for enhancing the input signals and providing a processed output signal.

In the present context, a hearing aid, e.g. a hearing instrument, refers to a device, which is adapted to improve, augment and/or protect the hearing capability of a user by receiving acoustic signals from the user's surroundings, generating corresponding audio signals, possibly modifying the audio signals and providing the possibly modified audio signals as audible signals to at least one of the user's ears. Such audible signals may e.g. be provided in the form of acoustic signals radiated into the user's outer ears and/or acoustic signals transferred as mechanical vibrations to the user's inner ears through the bone structure of the user's head and/or through parts of the middle ear.

The hearing aid may be configured to be worn in any known way, e.g. as a unit arranged behind the ear with a tube leading radiated acoustic signals into the ear canal or with an output transducer, e.g. a loudspeaker, arranged close to or in the ear canal, as a unit entirely or partly arranged in the pinna and/or in the ear canal, as a unit, e.g. a vibrator, attached to a fixture implanted into the skull bone, etc. The hearing aid may comprise a single unit or several units communicating (e.g. acoustically, electrically or optically) with each other. The loudspeaker may be arranged in a housing together with other components of the hearing aid or may be an external unit in itself (possibly in combination with a flexible guiding element, e.g. a dome-like element).

A hearing aid may be adapted to a particular user's needs, e.g. a hearing impairment. A configurable signal processing circuit of the hearing aid may be adapted to apply a frequency and level dependent compressive amplification of an input signal. A customized frequency and level dependent gain (amplification or compression) may be determined in a fitting process by a fitting system based on a user's hearing data, e.g. an audiogram, using a fitting rationale (e.g. adapted to speech). The frequency and level dependent gain may e.g. be embodied in processing parameters, e.g. uploaded to the hearing aid via an interface to a programming device (fitting system) and used by a processing algorithm executed by the configurable signal processing circuit of the hearing aid.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 shows a box diagram of an embodiment of a hearing aid according to the present disclosure.

FIG. 2a and FIG. 2b shows schematic views of a hearing aid with the housing removed according to an embodiment of the present disclosure.

FIG. 3 shows a schematic perspective view of a hearing aid with the housing removed according to an embodiment of the present disclosure.

The figures are schematic and simplified for clarity, and they just show details which are essential to the understanding of the disclosure, while other details are left out. Throughout, the same reference signs are used for identical or corresponding parts.

Further scope of applicability of the present disclosure will become apparent from the detailed description given hereinafter. However, it should be understood that the detailed description and specific examples, while indicating preferred embodiments of the disclosure, are given by way of illustration only. Other embodiments may become apparent to those skilled in the art from the following detailed description.

### DETAILED DESCRIPTION OF EMBODIMENTS

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include micro-electronic-mechanical systems (MEMS), integrated circuits (e.g. application specific), microprocessors, microcontrollers, digital signal processors (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

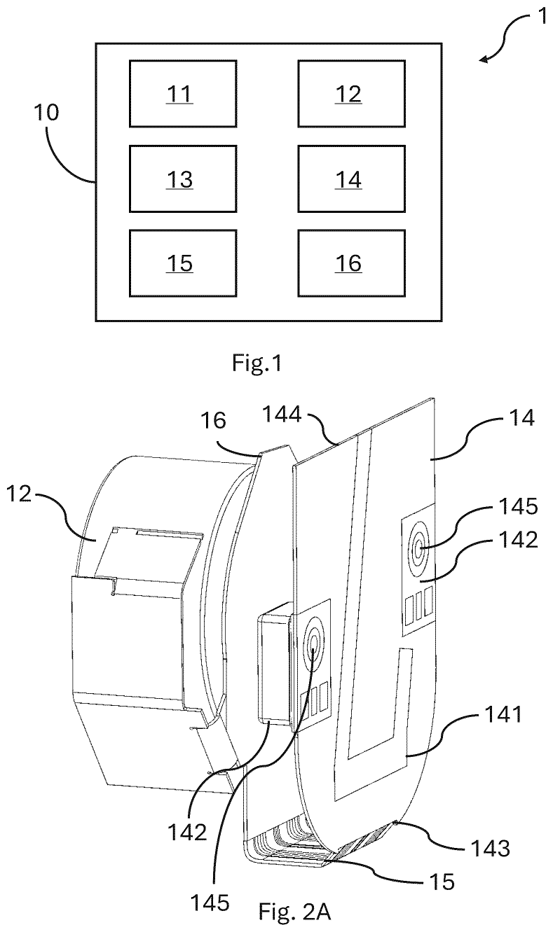

Referring initially to FIG. 1 which shows a box diagram of an embodiment of a hearing aid 1 according to the present disclosure. The hearing aid comprises a housing 10. The housing 10 is configured to be positioned in an ear of a user. The housing 10 may be a custom molded housing for an ITE hearing aid. The housing 10 comprises an input transducer 11 configured to provide an electrical signal. The input transducer 11 may be a microphone. The input transducer 11 may form part of an input unit comprising a plurality of input transducers. The housing 10 comprises a power source 12. The power source 12 may be a battery. The power source 12 may be a rechargeable battery. The housing 10 comprises a processing unit 13. The processing unit 13 is configured to receive a first input signal based on the electrical signal, and process the first input signal for provision of an output signal. The processing unit 13 may comprise one or more processors. The housing 10 comprises a first substrate 14. The first substrate 14 comprises a slot antenna 141 configured to transmit and/or receive wireless signals. The first substrate 14 comprises an upper edge 144 and a lower edge 143, where the upper edge 144 is arranged opposing the lower edge 143, where the upper edge 144 lies above the lower edge 143 when the hearing aid 1 is worn in an intended position by the user. The first substrate 14 may be formed by a PCB or a flexible PCB. The slot antenna 141 may be formed directly in the first substrate 14. The housing 10 comprises a second substrate 15. The second substrate is electrically connected to the power source 12. The second substrate 15 may be formed by a PCB or a flexible PCB. The second substrate 15 may comprise electrical routing for electrically connecting the second substrate to the power source 12. The housing 10 comprises a connecting section 16. The connecting section 16 electrically connects the first substrate 14 to the power source 12 via the second substrate 15. The connecting section 16 comprises a feed line for feeding the slot antenna 141.

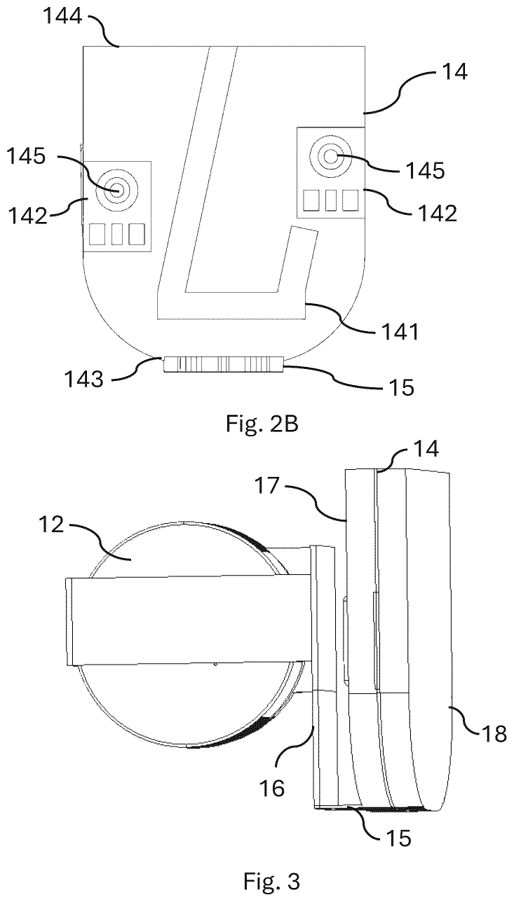

FIG. 2a and FIG. 2b shows schematic views of a hearing aid 1 with the housing 10 removed according to an embodiment of the present disclosure. The first substrate 14 is provided with a substantially planar geometry. The first substrate 14 is provided with an upper edge 144 and opposite the upper edge 144 a lower edge 143. The first substrate 14 comprises two microphones 142. In general, the first substrate 14 may comprise one or more electrical components 142, e.g., microphones, sensors, speakers, diodes, etc. The first substrate 14 comprises first electrical routing for the one or more electrical components 142. The first substrate 14 may be a flexible printed circuit board or a printed circuit board, the first electrical routing may then comprise one or more traces on the first substrate 14. In the shown embodiment one of the microphones 142 is arranged proximate a first edge extending between the upper edge and the lower edge. The other microphone 142 is arranged proximate a second edge extending between the upper edge 144 and the lower edge 143 opposite the first edge. The inlets 145 of the microphones are arranged such that they are substantially within the same horizontal plane when the hearing aid is worn in an intended position.

The first substrate 14 comprises a slot antenna 141. The slot antenna 141 is fed at the 50 Ohm point. The slot antenna 141 is open-ended and formed as a quarter wavelength slot. The open-end of the slot antenna 141 is arranged at the upper edge 144. The slot antenna 141 is fed proximate the lower edge 143. The first substrate 14 defines a ground plane for the slot antenna 141. The slot antenna is in the shown embodiment formed as a slot antenna. Specifically, the slot is formed in the shape of an inverted number seven.

At the lower edge 143 of the first substrate 14, the first substrate is connected to a connecting section 15. The connecting section 15 may be a flexible printed circuit board. The connecting section 15 may be provided as an integral part of the first substrate 14. The connecting section 15 comprises a feed line for feeding the slot antenna 141. The connecting section comprises electrical routing for the microphones 145. The feed line comprised by the connecting section 15 may be a co-planar waveguide. The co-planar waveguide may form part of the electrical routing for the one or more electrical components 142.

The connecting section 15 is connected to the second substrate 16. The second substrate 16 is provided with a substantially planar geometry. The second substrate 16 may be a printed circuit board or a flexible printed circuit board. The second substrate 16 is electrically connected to a battery 12. The battery 12 is able to provide power to the slot antenna 141 and other electrical components 142 of the first substrate 14. The connecting section 15 electrically connects the first substrate 14 to the second substrate 16, thus, allowing for power and data to be communicated between the first substate 14 and the second substrate 16.

The second substrate 16 may comprises a first side and a second side opposite the first side. The first side may face towards the power source 12, and the second side may face towards the first substrate 14.

FIG. 3 shows a schematic perspective view of a hearing aid 1 with the housing removed according to an embodiment of the present disclosure. The shown hearing 1 may comprise the same elements as the hearing aids 1 depicted and described in relation to FIGS. 1, 2A and 2B. In the shown embodiment, the hearing aid 1 comprises a first loading substrate 18 and a second loading substrate 17. The first loading substrate 18 is arranged over the slot antenna 141 and the second loading substrate 18 is arranged under the slot antenna 141 opposite the first loading 18 substrate. The first loading substrate 18 and the second loading substrate 17 are configured to load the slot antenna.

The second substrate 16 may comprises a first side and a second side opposite the first side. The first side may face towards the power source 12, and the second side may face towards the first substrate 14.

It is intended that the structural features of the devices described above, either in the detailed description and/or in the claims, may be combined with steps of the method, when appropriately substituted by a corresponding process.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element, but an intervening element may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method are not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art.

The claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

1. A hearing aid comprising a housing, wherein the housing is configured to be positioned in an ear of a user, the housing comprising:
an input transducer configured to provide an electrical signal,
a power source,
a processing unit configured to:
receive a first input signal based on the electrical signal, and
process the first input signal for provision of an output signal,
a first substrate comprising a slot antenna configured to transmit and/or receive wireless signals, wherein the first substrate comprises an upper edge and a lower edge, wherein the upper edge is arranged opposing the lower edge, wherein the upper edge lies above the lower edge when the hearing aid is worn in an intended position by the user,
a second substrate electrically connected to the power source, and
a connecting section electrically connecting the first substrate to the power source via the second substrate, wherein the connecting section comprises a feed line for feeding the slot antenna.

2. A hearing aid according to claim 1, wherein the hearing aid comprises a faceplate, and wherein the first substrate conforms to the faceplate.

3. A hearing aid according to claim 1, wherein the slot antenna is open-ended and formed as a quarter wavelength slot.

4. A hearing aid according to claim 3, and wherein the open-end of the slot antenna is arranged at the upper edge.

5. A hearing aid according to claim 1, wherein the slot antenna is fed proximate the lower edge.

6. A hearing aid according to claim 1, wherein the first substrate comprises one or more electronic components, and first electrical routing for the one or more electrical components.

7. A hearing aid according to claim 6, wherein the first substrate comprises a first outer layer, a second outer layer opposite the first outer layer and one or more internal layers, where the one or more internal layers comprises the first electrical routing.

8. A hearing aid according to claim 7, wherein the connecting section comprises second electrical routing for the one or more electrical components.

9. A hearing aid according to claim 1, wherein the first substrate comprises a first microphone arranged proximate a first edge extending between the upper edge and the lower edge, and a second microphone arranged proximate a second edge extending between the upper edge and the lower edge opposite the first edge.

10. A hearing aid according to claim 9, wherein the first microphone and the second microphone are arranged such that an inlet of the first microphone and an inlet of the second microphone are substantially within the same horizontal plane when the hearing aid is worn in an intended position.

11. A hearing aid according to claim 1, wherein the feed line for feeding the slot antenna comprises a co-planar waveguide.

12. A hearing aid according to claim 1, wherein the connecting section comprises a flexible printed circuit board.

13. A hearing aid according to claim 1, wherein the slot antenna comprises a meandering slot antenna.

14. A hearing aid according to claim 1, comprising a first loading substrate and a second loading substrate, wherein the first loading substrate is arranged over the slot antenna and the second loading substrate is arranged under the slot antenna opposite the first loading substrate, wherein the first loading substrate and the second loading substrate are configured to load the slot antenna.

15. A hearing aid according to claim 1, wherein the second substrate comprises a first side and a second side opposite the first side, wherein the first side faces towards the power source, and wherein the second side faces towards the first substrate.
